(19) United States
(12) Patent Application Publication
(10) Pub. No.: US 2014/0202320 A1
(43) Pub. Date: Jul. 24, 2014

(54) MUSICAL INSTRUMENT DEVICE AND METHOD

(71) Applicants: Andrew J. WHITE, Morgantown, WV (US); Daniel WHITE, Baltimore, MD (US)

(72) Inventors: Andrew J. WHITE, Morgantown, WV (US); Daniel WHITE, Baltimore, MD (US)

(21) Appl. No.: 14/162,190

(22) Filed: Jan. 23, 2014

Related U.S. Application Data
(60) Provisional application No. 61/756,188, filed on Jan. 24, 2013.

(51) Int. Cl. G10H 3/18

(52) U.S. Cl. CPC G10H 3/181
USPC 84/731; 84/723

(57) ABSTRACT

Systems and methods for producing sounds in musical instruments are provided. In one approach, a musical instrument includes: a primary sound producing mechanism; a primary sound producing surface, wherein movement of the primary sound producing mechanism by a user causes the primary sound producing surface to produce a sound; a secondary device contacting the primary sound producing surface; and a controller operatively connected to the secondary device and configured to cause the secondary device to vibrate the primary sound producing surface to produce a sound by the musical instrument.

### CROSS REFERENCE TO RELATED APPLICATION

This application claims priority to U.S. Application No. 61/756,188, filed Jan. 24, 2013, the contents of which are incorporated by reference herein in their entirety.

### FIELD OF THE INVENTION

The invention relates to musical instruments and, more particularly, to methods and systems for producing sound with an instrument using a secondary device.

### BACKGROUND

A stringed instrument produces sound when a string vibrates a mass of the stringed instrument. The mass may include, for example, structural elements defining an acoustic chamber, such as the top, bottom, and side walls of a guitar. The mass of the instrument creates sound by amplifying the string vibration. The sound level of a stringed instrument is commonly amplified by vibrating another mass, such as a speaker cone that is separate and/or distinct from the body of the stringed instrument.

### SUMMARY

In a first aspect of the invention, there is a musical instrument comprising: a primary sound producing mechanism; a primary sound producing surface, wherein movement of the primary sound producing mechanism by a user causes the primary sound producing surface to produce a sound; a secondary device contacting the primary sound producing surface; and a controller operatively connected to the secondary device and configured to cause the secondary device to vibrate the primary sound producing surface to produce a sound by the musical instrument.

In another aspect of the invention, there is a system comprising the musical instrument comprising the primary sound producing mechanism, the primary sound producing surface, the secondary device, and the controller. The system also comprises an external computer device. The computer device comprises a processor, a memory, and programming stored in the memory and executed by the processor that causes the computer device to: send a signal to the secondary device that causes the secondary device to produce a sound in the musical instrument by vibrating the primary sound producing surface.

In another aspect of the invention, there is a method that uses the musical instrument comprising the primary sound producing mechanism, the primary sound producing surface, the secondary device, and the controller. The method comprises using the secondary device to one of: amplify a sound created by the primary sound producing mechanism; produce a sound in the musical instrument based on a signal received from a computer device that is external to and separate from the musical instrument.

In another aspect of the invention, there is a system comprising: a communication device for receiving and/or sending wireless signals; a capture device that captures mechanical vibrations such as a magnetic pickup, piezo, or microphone; a processor device that converts a signal in one form of energy to another form of energy; an actuator device that accepts energy and produces movement, such as a voice coil or piezo actuator; and an energy source, such as a battery. The communication device, capture device, processor device, actuator device, and energy source are configured to be attached to a musical instrument, and are further configured to cause the actuator device to vibrate a sound producing surface of the musical instrument to produce a sound by the musical instrument.

In another aspect of the invention, there is a method comprising: providing the system including the communication device, the capture device, the processor device, the actuator device, and the energy source; and providing instructions for how to install the system in a musical instrument.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 shows a system according to aspects of the invention;

FIGS. 2 and 3 show exemplary attachment locations on sound producing surfaces of an instrument in accordance with aspects of the invention;

FIGS. 4 and 5 show a secondary device installed in an instrument in accordance with aspects one exemplary implementation of the invention;

FIG. 6 depicts creating a wireless sound system within an instrument that allows the secondary device to be controlled by an outside device in accordance with aspects of the invention;

FIG. 7 depicts a musical instrument with two way data communication in accordance with aspects of the invention;

FIG. 8 depicts using a speaker having a similar shape and/or material to that of the instrument being emulated in accordance with aspects of the invention;

FIG. 9 depicts using a software program in accordance with aspects of the invention;

FIG. 10 shows an exemplary system 100 in accordance with further aspects of the invention; and

FIGS. 11a and 11b show exemplary attachments for connecting a device to an instrument in accordance with aspects of the invention.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The invention relates to musical instruments and, more particularly, to methods and systems for producing sound with an instrument using a secondary device. According to aspects of the invention, a secondary device is added to a stringed instrument to vibrate the mass of the instrument to also create sound. The secondary device can increase the amplitude of the sound derived from the string, the primary device, when played at the same frequency of the vibration of the string. This amplification by the secondary device increases the volume of the notes without an external speaker and creates tone more similar to the original tone than is possible through an external speaker. The secondary device can also vibrate the instrument to create auxiliary sounds at any frequency independent of the sound created by the string.

Implementations of the invention comprise a musical instrument with a secondary device within the instrument to amplify the tone being produced by the primary playing surface of the musical instrument. The secondary device may comprise two or more mechanisms for producing sound. Embodiments use wireless communication to the musical instrument. Implementations comprise a musical instrument with two way data communication. Additional aspects of the invention contemplate using the secondary device in an instrument having a similar shape and/or material to that of the instrument being emulated. Even further aspects of the invention include a software application (e.g., an “app”) designed to record sounds from a musical instrument and replay back to the same instrument with or without adjustment or to add sounds.

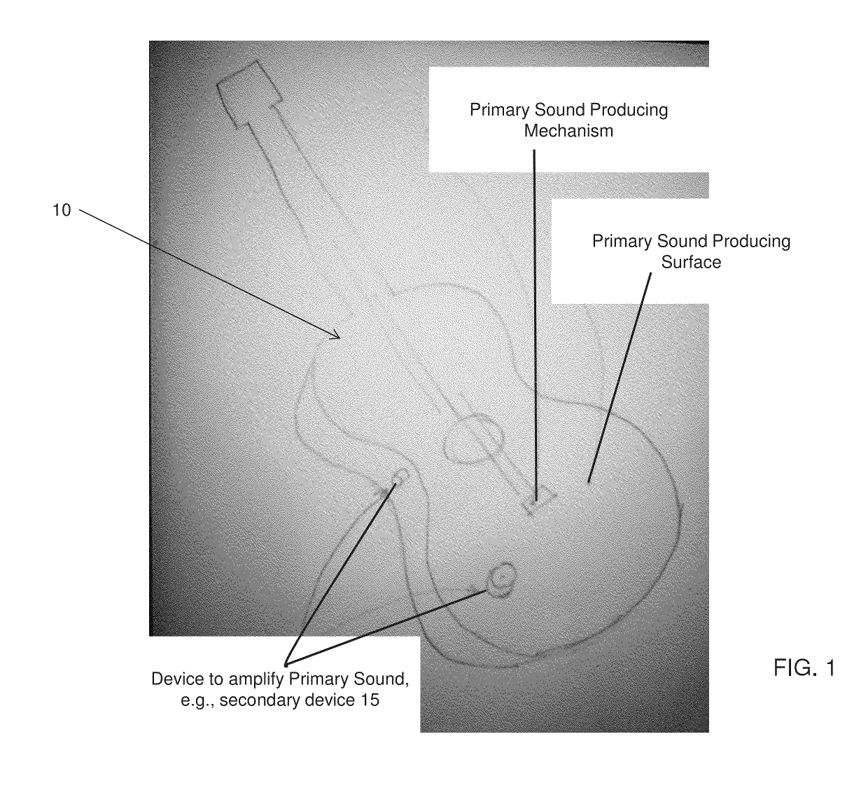

FIG. 1 shows a system according to aspects of the invention, the system including a musical instrument with a device within that amplifies the tone being produced by the primary playing surface. In embodiments the system includes a musical instrument 10, such as a guitar. The instrument 10 includes a primary sound producing mechanism, e.g., strings. The instrument 10 also includes a primary sound producing surface, e.g., the body of the guitar that has surfaces defining an acoustic chamber. In accordance with aspects of the invention, the system also includes at least one secondary sound producing mechanism 15 (referred to herein as a secondary device 15) operatively contacting the primary sound producing surface, the secondary device 15 being structured and arranged to cause the primary sound producing surface to vibrate at a desired frequency. By using the secondary device 15, the actual volume of the instrument (guitar) may be increased without using a speaker or external wires. The secondary device 15 vibrates the mass of the instrument to increase amplitude of the frequency played on the primary device, similar to how strings vibrate the mass of a guitar. Notably, in embodiments, the secondary device 15 vibrates the same sound producing surface that is vibrated by the primary sound producing mechanism (e.g., the strings), rather than a vibrating a separate, distinct speaker.

Although aspects of the invention are described herein with respect to a guitar, it is noted that the invention is not limited to use with a guitar, and aspects of the invention may be used with any desired musical instrument having a primary sound producing mechanism and a primary sound producing surface. Moreover, the invention is not limited to using one secondary device, and any desired number of secondary devices may be used with a musical instrument within the scope of the invention.

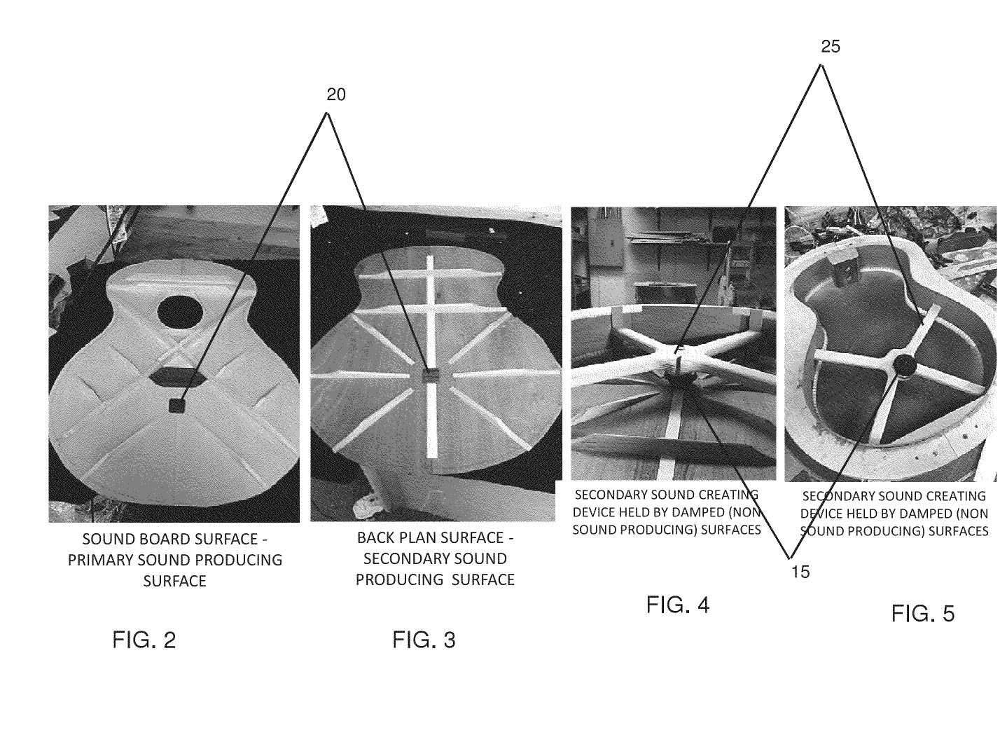

FIG. 2 shows a fret board surface (also referred to as a soundboard surface or a guitar top surface), which may be the primary sound producing surface of the instrument 10. FIG. 3 shows a back plan surface of a guitar, which may be a secondary sound producing surface of the instrument 10. The shaded areas 20 indicate exemplary locations on the primary sound producing surface and the secondary sound producing surface where the secondary device may be placed into direct physical contact with the surfaces. The invention is not limited to these locations, however, and the secondary device 15 may be located at any desired location on the instrument.

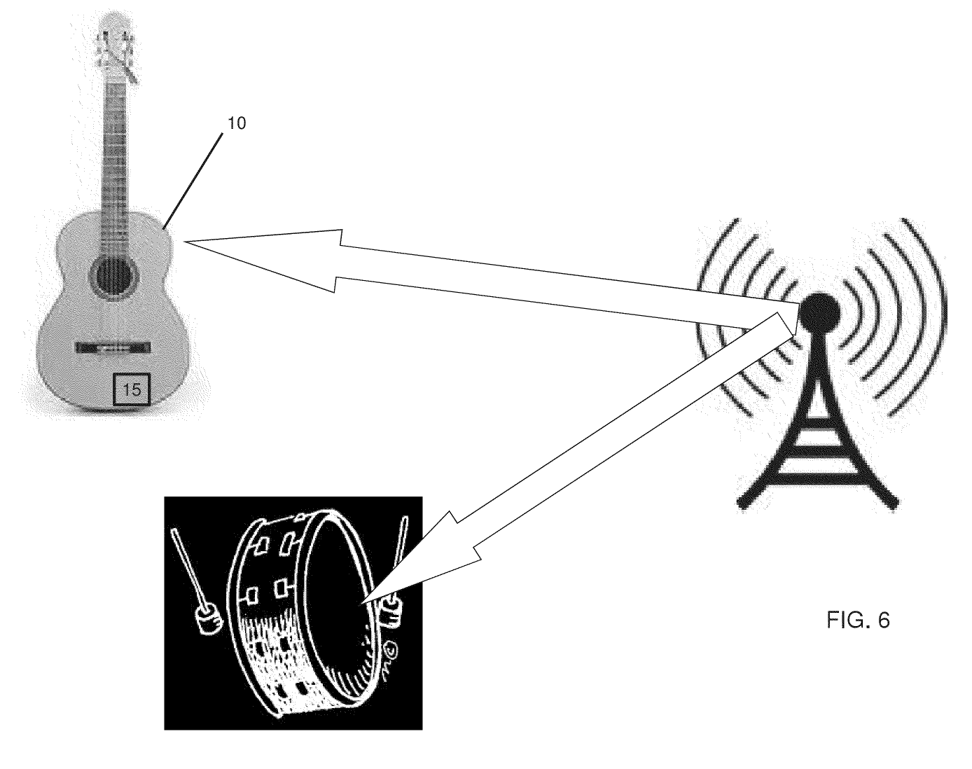

FIGS. 4 and 5 show the secondary device 15 installed in the instrument 10 in accordance with aspects one exemplary implementation of the invention. In embodiments, the secondary device 15 is held by damped surfaces 25 (i.e., structural members inside the guitar) that are not sound producing surfaces. As shown in FIG. 4, the damped surfaces 25 hold the secondary device 15 in a location that places the secondary device 15 in contact with the interior surface of the back surface of the guitar (e.g., the back plan surface as depicted in FIG. 3). As shown in FIG. 5, the damped surfaces 25 hold the secondary device 15 in a location that places the secondary device 15 in contact with the interior surface of the front surface of the guitar (e.g., the guitar top surface/soundboard as depicted in FIG. 2). As shown in FIGS. 4 and 5, the damped surfaces 25 may comprise a brace or other structural member that contacts the side surfaces of the guitar body, but that avoids contact with the sound producing surfaces of the guitar. The damped surfaces may be structured and arranged to permit the secondary device 15 to be mounted in at least two different locations (e.g., those shown in FIGS. 4 and 5). According to aspects of the invention, the mass of the strings (played on the fret board) are the primary device to vibrate the body of the guitar, and the secondary device 15 inputs additional vibrational energy to vibrate the body of the guitar. The secondary device 15 may include, but is not limited to, a voice coil or piezo elements. The invention is not limited to using structural members for holding the secondary device 15, and instead the secondary device 15 may be connected to one of the sound producing surfaces of the instrument in any suitable manner. For example, the secondary device 15 may be connected to one of the sound producing surfaces of the instrument using adhesive (e.g., glue, etc.), tape, magnets, or the like. Moreover, the invention is not limited to the secondary device 15 being placed inside an instrument. Instead, the secondary device 15 may be connected to an exterior of one of the sound producing surfaces of the instrument, e.g., to an exterior of the top, side, or back surface of a guitar or the like.

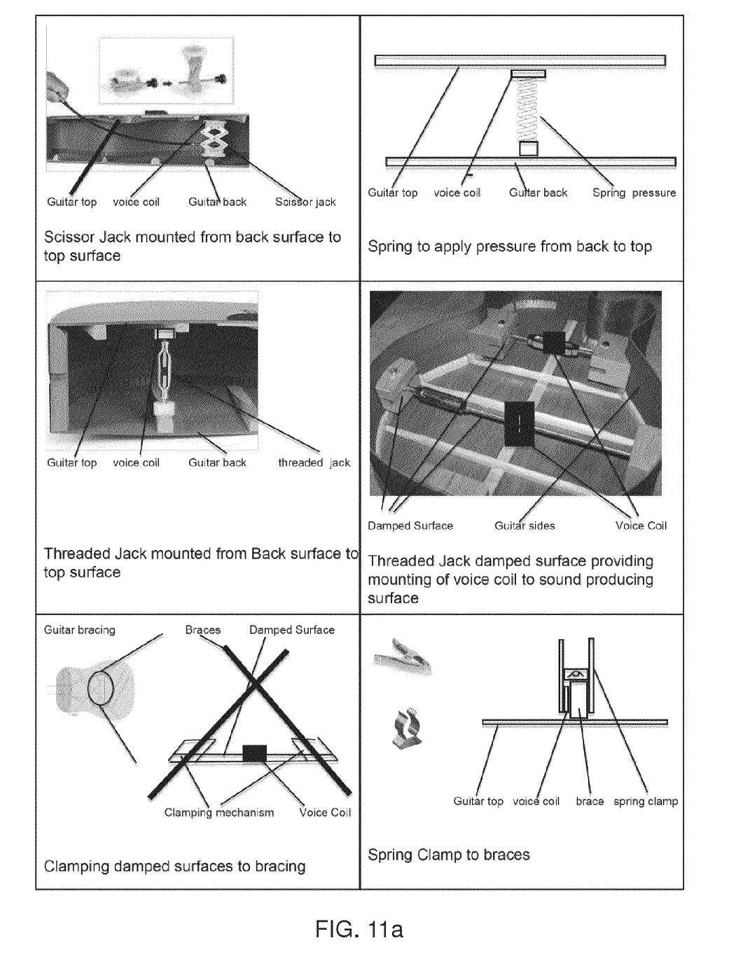

Implementations of the invention may include a power supply (e.g., a battery, etc.) and circuitry (e.g., processor, wiring, etc.) associated with the secondary device 15 that are used in driving the secondary device 15. For example, there may be a controller that is operatively connected to the secondary device 15 and configured to cause the secondary device 15 to vibrate a primary sound producing surface of an instrument to produce a sound by the musical instrument. In embodiments, the controller is a processor device 120 as shown in FIG. 10. The power supply (e.g., a battery) and circuitry may be mounted inside the instrument 10, e.g., inside the body of a guitar. In embodiments, the power supply (e.g., a battery) is an energy source 130 as shown in FIG. 10. The system may also include a transmitter/receiver mounted on or in instrument 10 and operatively connected to the secondary device 15, the transmitter/receiver being adapted to transmit signals to a computer device external of the instrument 10 and to receive signals from the computer device. The transmitter/receiver may be configured for wireless data communication. In embodiments, the transmitter/receiver is a communication device 110 as shown in FIG. 10. The controller (e.g., processor device 120) may be adapted to control actuation of the secondary device 15 (e.g., actuator device 125) based on signals provided by the transmitter/receiver (e.g., communication device 110).

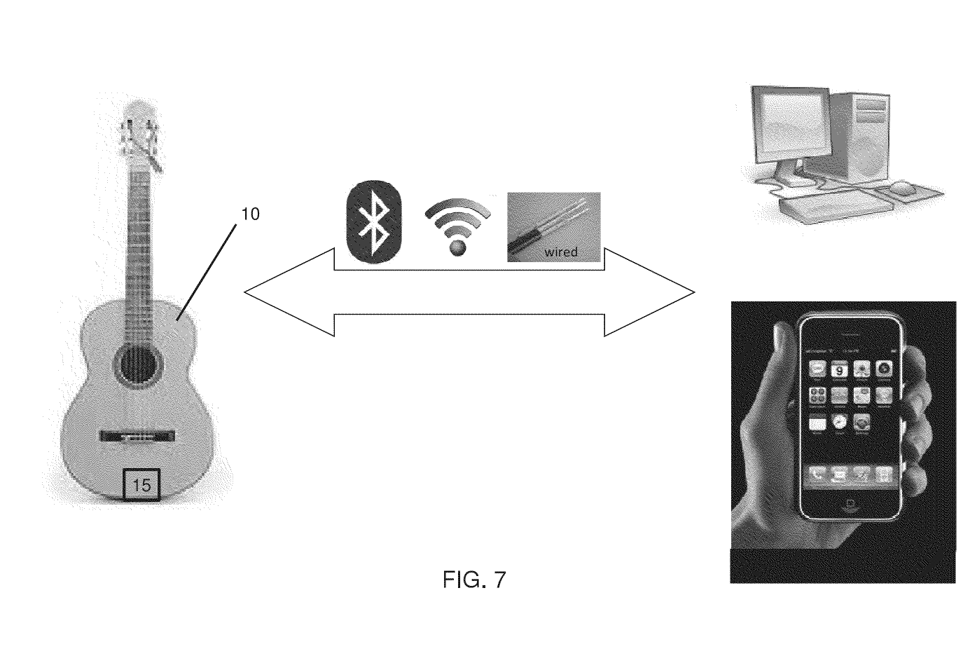

FIG. 6 depicts creating a wireless sound system within the instrument 10 (e.g. by integrating wireless technology such as Bluetooth, etc.) that allows the secondary device 15 to be controlled by an outside device (e.g. a smartphone or tablet). In embodiments, wireless communication may be used to transmit a signal to the secondary device 15 mounted in the instrument, which signal causes the secondary device 15 to vibrate the sound producing surface of the instrument to produce a desired tone. In one example, a computer device may transmit a signal to the secondary device 15 which causes the secondary device 15 to vibrate the primary sound producing surface of the instrument 10 to produce a tone, such as a drum beat. The user of the instrument 10 may then play the instrument (e.g., strum the strings) to vibrate the primary sound producing surface of the instrument 10 to produce a sound that is in addition to the sound being produced by the secondary device 15. In this manner, the secondary device 15 may be used to produce accompanying sounds to the instrument 10 by using the same primary sound producing surface that is used by the primary sound producing mechanism (e.g., the strings).

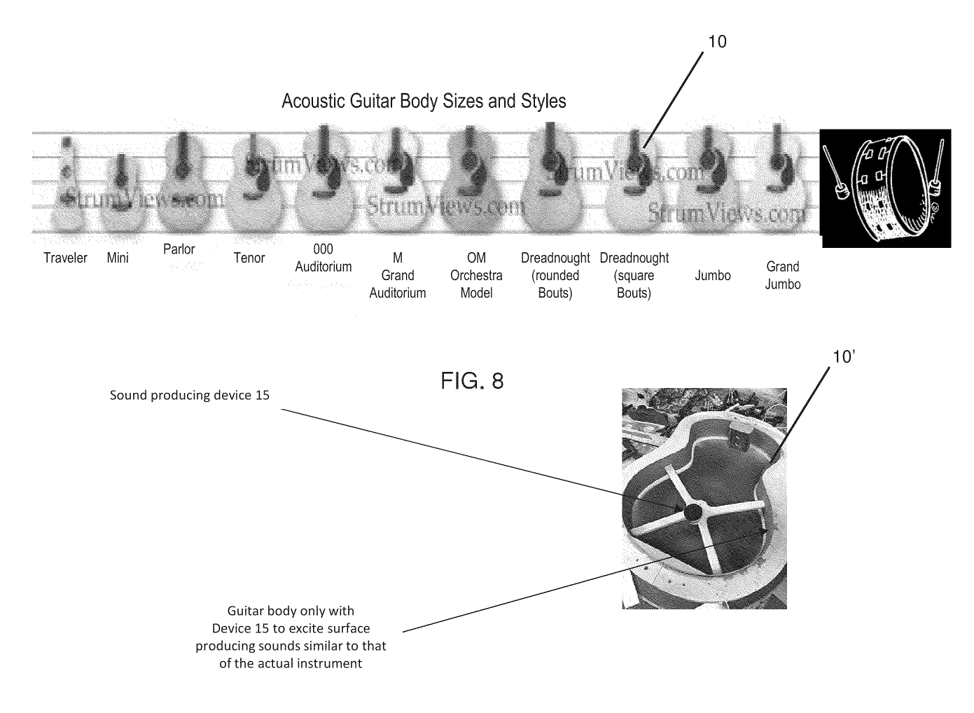

FIG. 7 depicts the musical instrument 10 with two way data communication in accordance with aspects of the invention. In embodiments, the secondary device 15 includes a wireless transmitter (or is connected to a wireless transmitter inside the instrument 10) that uses wireless communication (e.g., Bluetooth) to communicate the sound being played by the instrument 10 to a computer device (e.g., a smart phone, laptop computer, desktop computer, tablet computer, etc.). The sound is processed in any desired manner in the computer device. The computer device then wirelessly transmits a signal back to the secondary device 15 which is activated to cause the instrument to vibrate in accordance with the processing that was performed by the computer device. For example: 1) a guitar player can play a series of notes on the instrument 10; 2) the notes could be transmitted by Bluetooth to the smart phone which records them; and 3) the notes could be sent to the secondary device (inside the guitar) to continuously play the notes that were originally created by the primary device (strings and guitar) to create a “loop”. As another example, a user of the instrument 10 may play a chord of the instrument 10 using the strings. This chord may be recorded at a computer device that is external to the instrument 10. The computer device may transmit a signal to the secondary device 15 that causes the secondary device 15 to vibrate the primary sound producing surface of the instrument 10 to play the chord in a loop. The user of the instrument 10 may then utilize the primary sound mechanism (the strings) to play tones in addition to the chord that is being looped by the secondary device 15.

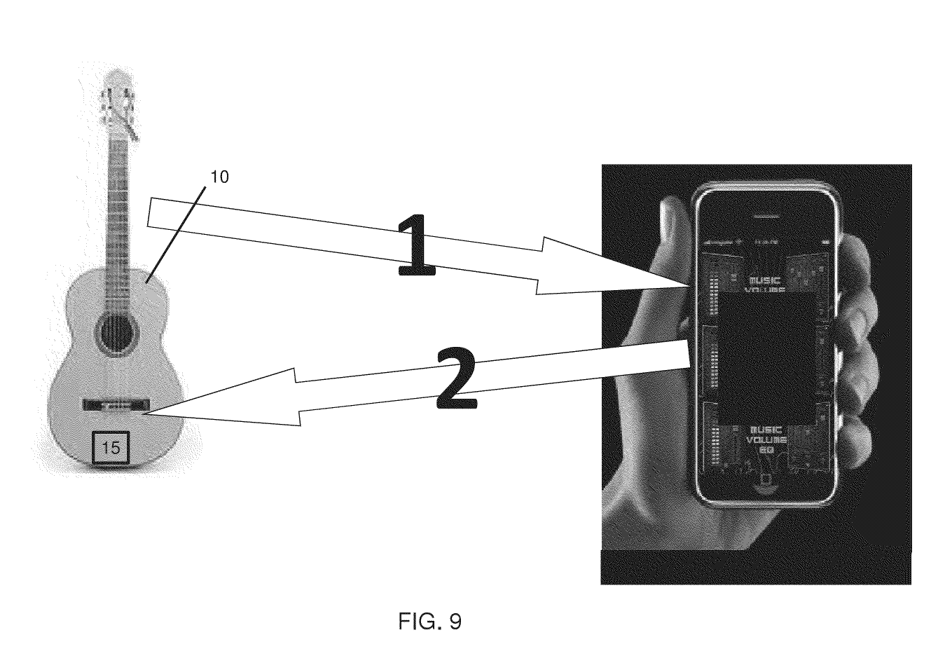

FIG. 8 depicts using a speaker having a similar shape and/or material to that of the instrument being emulated in accordance with aspects of the invention. A speaker can be created in the likeness of the instrument being played in order to reproduce sound more “true” to the tone of the original instrument. For example, if a guitar player is on stage playing a Dreadnought 1957, a speaker could be built to sound like a Dreadnought 1957. More specifically, the instrument 10 may comprise a particular type of guitar, e.g., a Dreadnought 1957. In accordance with aspects of the invention, a second instrument 10′ that is also a Dreadnought 1957 may be obtained and fitted with the secondary device 15. As the musician plays the first instrument (e.g., the first Dreadnought 1957), the system transmits a signal to the secondary device 15 mounted in the second instrument 10′ (e.g., the second Dreadnought 1957), which causes the secondary device 15 to provide vibrational energy to the primary sound producing surface of the second instrument 10′ that causes the second instrument 10′ to replicate the tone of the first musical instrument. In this manner, the second instrument 10′ is used as a speaker that replicates the tone of the first instrument 10 via the secondary device 15 mounted in the second instrument 10′. Since the second instrument 10′ has an almost identical shape as the first instrument 10, this type of speaker produces a truer representation of the sound of the first instrument (e.g., compared to a conventional cone-shaped speaker).

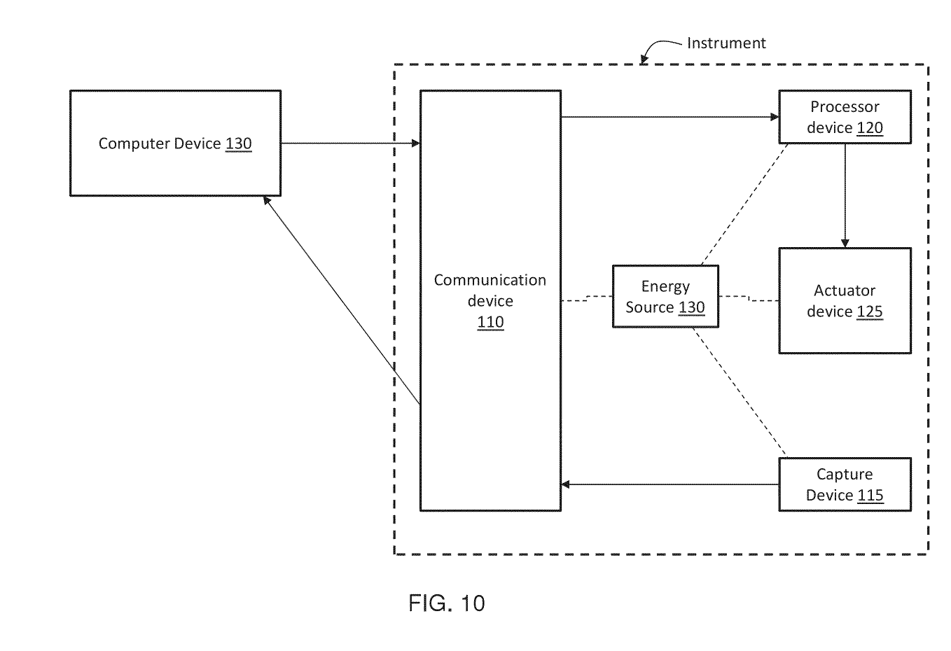

FIG. 9 depicts a software program (e.g., an app for a mobile computer device such as a smart phone) in accordance with aspects of the invention. In embodiments, the software program is designed to record sound from the instrument 10 and replay back to the instrument 10 via the secondary device 15. The application can be created to optimize the hardware in the guitar.

Additional aspects of the invention include a device consisting of two or more mechanisms for producing sound: a primary sound producing mechanism (e.g., a guitar example is an acoustic chamber defined in part by the guitar top surface/soundboard) and a secondary sound producing mechanism (e.g., a guitar example is voice coil/piezo/thumper, such as). The secondary sound producing mechanism may be a secondary vibration producing device (secondary device 15) that is able to be lifted and replaced from and to the surface of the instrument. The secondary vibration producing device is able to be turned on or off. The secondary vibration producing device may be arranged on a surface/side other than guitar top surface/soundboard/side. The secondary vibration producing device (guitar example is voice coil/piezo) may be on the same surface/side as the fret board.

Additional aspects of the invention include a musical instrument with a device (secondary device 15) within the instrument to amplify the tone being produced by the primary sound producing surface of the instrument.

Additional aspects of the invention include a musical instrument with two way data communication. This may include, for example, communication out of instrument to a smart phone, computer, recorder, equalizer, or other and reciprocal data communication back to instrument. Aspects of the invention may include a switch or sensor on the musical instrument used to communicate states (i.e., start recording, stop recording, increase volume, add other sounds, etc.) of the instrument to the smart phone, computer, recorder, equalizer, or other device. Aspects of the invention may include a switch or sensor on the smart phone, computer, recorder, equalizer, or the like to communicate states (i.e., start recording, stop recording, increase volume, add other sounds, etc.) back to the instrument. In embodiments, the data is communicated out of the instrument to be processed (e.g., remove noise, noise canceling, amplify, modulate, or the like) by the smart phone, computer, recorder, equalizer, or the like.

Additional aspects of the invention include wireless communication to secondary sound producing mechanism (secondary device 15) within a musical instrument. The communication may be communication from another instrument. The communication may be communication from the internet (i.e., another person playing at the same time through one instrument or downloading a song and playing on the instrument.

Additional aspects of the invention include an application (app or program) designed to capture data from an instrument and replay to the same or another instrument using the secondary device 15.

Additional aspects of the invention include a speaker with the shape of a musical instrument thus resonating as a result of input from the secondary device 15 and producing similar sounds to that of the real instrument and/or a surface speaker on a guitar.

Additional aspects of the invention include a wireless charging station that functions as a stand for the instrument could also charge the batteries that are used to power the device.

Further aspects of the invention include the device being used for the education of guitar players. A player can learn exactly what his or her guitar would sound like when playing a certain chord correctly. For example, the external computer device can transmit a signal to a secondary device 15 mounted inside an instrument 10 that causes the secondary device 15 to vibrate the primary sound producing surface of the instrument 10 at a particular note or chord. At the same time, the computer device may visually display an indication of the particular note or chord that is being played (e.g., via the visual screen of the computer device). The software program on the computer device may be configured to permit a user to select a note or chord on the computer device (e.g., via a graphical user interface), which selection causes the computer device to transmit a signal to the secondary device 15 to play the selected note or chord on the instrument 10. Additionally, a student can practice the lead notes of a song while the secondary device 15 plays the rhythm, drums, and bass parts of the song on the same instrument 10 that the student is playing.

Even further aspects of the invention include a smart phone's accelerometer being used as a switch to engage features of the device described herein, and/or include a smart phone's voice command being used as a switch to engage the features described herein. For example, a user may hold their smart phone in their pocket and jiggle the phone (e.g., with a body movement) to start and/or stop recording of music being played on the instrument 10. As another example, the user may use voice commands to start and/or stop recording of music being played on the instrument 10. Such controls that do not rely on pressing a button on the smart phone may be useful to eliminate gaps at the beginning and end of recordings when playing instruments with one's hands. The invention is not limited to using an accelerometer or voice commands. Instead, aspects of the invention include controlling the secondary device 15 via any suitable input mechanism of the computer device, including but not limited to: keyboard, mouse, graphical user interface, touch screen, etc. Further, the invention is not limited to controlling only start and/or stop recording/playing. Instead, aspects of the invention include using the computer device to control the secondary device 15 to adjust any suitable function of the secondary device 15, including but not limited to: volume up, volume down, mute, loop playback of a recorded sounds, etc.

Still further aspects of the invention include a first user playing a first instrument 10 using the primary mechanism (e.g., the strings), a first computer device recording what is played on the first instrument, the first computer device communicating a signal to a second computer device (e.g., via the Internet or other network), the second computing device transmitting a control signal to a secondary device 15 contained in a second instrument 10′, wherein the control signal causes the secondary device 15 to vibrate the primary sound producing surface of the second instrument 10′ to mimic the sound that was played by the first instrument 10. In this manner, the second user of the second instrument 10′ may hear what is played by the first user of the first instrument 10.

Additional aspects of the invention include the ability to mute strings while the device is exciting the guitar body. This is important because if you wanted to let your guitar play by itself for a moment, it will create sympathetic vibration from the strings.

Further aspects of the invention include an additional bracing system for the soundboard of the guitar.

According to aspects of the invention, the vibrating creating device (secondary device 15) may be placed on either the soundboard or the back surface of the guitar (instrument 10). The invention is not limited to these locations, however, and in some embodiments, the vibrating creating device (secondary device 15) may be placed on other parts of the instrument such as the sides of the guitar body, the guitar neck, etc.

In aspects of the invention, the components (e.g., transmitter, etc.) mounted inside the instrument push a signal outside the instrument, e.g., a computer device that is remote and separate from the instrument 10. The computer device adjusts or adds to the signal, which is then sent back to the secondary device 15 to cause the secondary device 15 to produce a sound in the instrument 10. Thus, implementations use hardware and software that are external to and separate from the instrument for signal processing, which reduces cost of the instrument 10 itself and allows for unlimited control possibilities. In particular exemplary embodiments, the inventive system locates the signal processing circuitry and controls in the computer device that is outside of and separate from the instrument, which allows for unlimited processing by physical users and/or virtual users acting on the instrument 10 via the external computing device and software controlling the secondary device 15.

Implementations of the invention acts on the primary sound producing surface of the instrument 10, e.g., the secondary device 15 vibrates the front or back wall of the acoustic chamber of the guitar body, rather than acting on the strings. The components of the inventive system that are mounted on the guitar may be mounted inside the guitar, e.g., hidden within the guitar without an enclosure for the user to grab or move. The secondary device 15 may also be connected to an exterior of one of the sound producing surfaces of the instrument, e.g., to an exterior of the top/front, side, or back surface of a guitar or the like.

In embodiments, the power supply for the secondary device 15 and associated circuitry inside the instrument 10 may be charged using contact-less inductive charging which transfers power using electro-magnetic flux. This method requires neither a connector nor a plug to re-charge the components inside the instrument 10. However, the invention is not limited to inductive charging, and other charging methods may be used.

According to aspects of the invention, the secondary device 15 produces sound in the instrument 10 by exciting the same acoustic chamber that is normally excited by the strings, i.e., there is not a additional chamber (e.g., resonating chamber, cavity, horn) in which the secondary device 15 operates. Moreover, implementations of the invention do not use additional masses to change tones. Aspects of the invention do not have additional chambers to amplify the sound but instead act directly on the guitar body thus amplifying only the tones that can be generated from the shape of the instrument 10, instead of using new/different chambers or shapes to create new/different tones. In some non-limiting exemplary embodiments, the objective is to generate true tones of the instrument 10 using the secondary device 15, and this is accomplished by the secondary device 15 acting on the same primary sound producing surface that is normally acted on the by the primary sound producing mechanism (i.e., the strings). In some non-limiting exemplary embodiments, the system avoids attaching a mass to the resonator to change the frequency, and, instead, an object is to create the same frequency (e.g., of that produced by the strings) by rigidly attaching the resonator to non-sound producing portions of the guitar (e.g., the secondary device 15 is held in place by braces that are connected to the non-sound producing side walls of the guitar as shown in FIGS. 4 and 5, and only the secondary device 15 is placed in contact with the sound producing surface of the guitar).

In additional embodiments, a signal generating device is not inside the instrument 10. Instead, the signal generating device that controls the secondary device 15 is located outside of the guitar, e.g., in a computer device such as a smart phone, laptop computer, tablet computer, etc. In some embodiments, only the pickup, receiver, communicator (e.g., transmitter/receiver) and amplifier (e.g., secondary device 15) are within the instrument 10.

Additional aspects of the invention include the system audibly educating a user by producing sounds that are exactly what the guitar should sounds like when the cord is played. This can be done because the resonating body is acting against the same surface that generates sound when the strings are played thus the sound is identical allowing for the user to audibly correct themselves until the correct note is played.

Additional aspects of the invention include:
1) A vibration generating device (e.g., secondary device 15) within a musical instrument capable of reproducing and amplifying the same sounds that the instrument is capable of without the device by acting on the same: sound producing surfaces (not the strings) of the instrument as well as being able to generate additional tones within the frequency spectrum of the original instrument (not by having additional walls or chambers added) again by resonating the same surfaces that generates sound in the original instrument without the additional device. (In aspects, this instrument is capable of being used only in sound producing mode and does not necessarily need a pickup in order to receive the raw data prior to being processed, i.e., the instrument can produce sound without a player strumming the strings, i.e., by just using the sound creating device (e.g., secondary device 15). For example, a pick up could be on a guitar in another room and projected to a guitar held by the user or the tones could be from a computer, phone or virtual, or virtual users.)
   a. Because the instrument creates tones substantially the same as when it is played with the strings it can be used to audibly teach users how to play.
   b. This device (e.g., secondary device 15) is also being capable of producing correct tones via acting on the same sound board that the primary function (strings) uses to create sound so that the end user can tune the instruments primary function (strings) to sound being generated from the device (e.g., secondary device 15) onto the primary sound board surface.
   c. A vibration producing device (e.g., secondary device 15) capable of being adjusted by the user allowing the user to place the device (e.g., secondary device 15) on various portions of the sound board, off the soundboard or on alternate surfaces of the guitar.
2) A musical instrument with pickup on the primary sound generating device (string or soundboard) and a vibration producing device (e.g., secondary device 15) on a surface other than the primary sound producing surface (sound board).
   a. A pickup that is moveable from one surface/location to another on the instrument allowing for signals from the instrument to be sent to the processor and sent back to one or multiple vibration creating devices (e.g., secondary device 15) on one or multiple surfaces of the instrument.
   b. A voice coil (e.g., secondary device 15) that can be mechanically or electrically engaged or disengaged from the surface of the instrument.
   c. A vibration creating device (e.g., secondary device 15) that is movable from one surface to another.
   d. Multiple pickups on various surfaces of the instrument allowing for signals from the guitar to be sent to the processor and sent back to one or multiple vibration creating device (e.g., secondary device 15) on one or multiple surfaces of the instrument
   e. A pick up being capable from being moved from one surface of the instrument to another.
   f. A pick up that can be mechanically or electrically engaged from the surface of the instrument.
3) Communicating in both directions from and to the guitar to an external device capable of processing, adding to, or removing from original signal generated from the instrument. This device (e.g., secondary device 15) being capable of being controlled, adjusted, recorded, or looped by the user or have additional signals added to it by other controllers (e.g., virtual users) via communication or connection to the phone, tv, computer, internet, other instruments, etc. and not limited to predetermined algorithms for generating sound.
   a. This two way communication being wireless. The communication may also be transmitted via wire.
   b. The two way wireless communication being capable of being connected to multiple control devices (computers, phones, internet) as well as being capable of being connected to devices with the same circuitry (another guitar with the secondary device 15) and thus have the same input tone played on a first instrument played on other instruments that it is connected to (paired with).
   c. Two way communication with a tone generating device external from the guitar (i.e., Computer, internet. virtual user, phone, etc) thus not limiting the device to predetermined algorithms and not burdening the instrument with additional cost, weight and size.
4) A wireless, contact-less charging on a musical instrument comprising the secondary device 15.

FIG. 10 shows an exemplary system 100 in accordance with further aspects of the invention. In embodiments, the system 100 includes a sub-system 105 comprising: a communication device 110 for both receiving and sending wireless signals; a capture device 115 that captures mechanical vibrations such as a magnetic pickup, piezo, or microphone; a processor device 120 that converts a signal in one form of energy to another form of energy; an actuator device 125 that accepts energy and produces movement, such as a voice coil or piezo, e.g., such as a secondary device 15 as described herein; and an energy source 130, such as a battery. The communication device 110, capture device 115, processor device 120, and actuator device 125 may be operatively connected to the energy source 130 to provide energy to each of these devices. In embodiments, the processor device 120 is a controller that operatively connected to the actuator device 125 and configured to cause the actuator device 125 to vibrate a primary sound producing surface of an instrument to produce a sound by the musical instrument.

In aspects of the invention, the sub-system 105 may be realized separate from a musical instrument, and subsequently connected to a musical instrument to produce sounds in the musical instrument in a manner similar to that described with respect to secondary device 15. The communication device 110 may be wireless communication device that is adapted to transmit and/or receive signals from a separate computer device 130, e.g., in a manner similar to that describe herein and in particular with respect to FIGS. 6 and 7. In this manner, the sub-system 105 may be sold separately from an instrument, and then applied to the instrument, e.g., by the consumer.

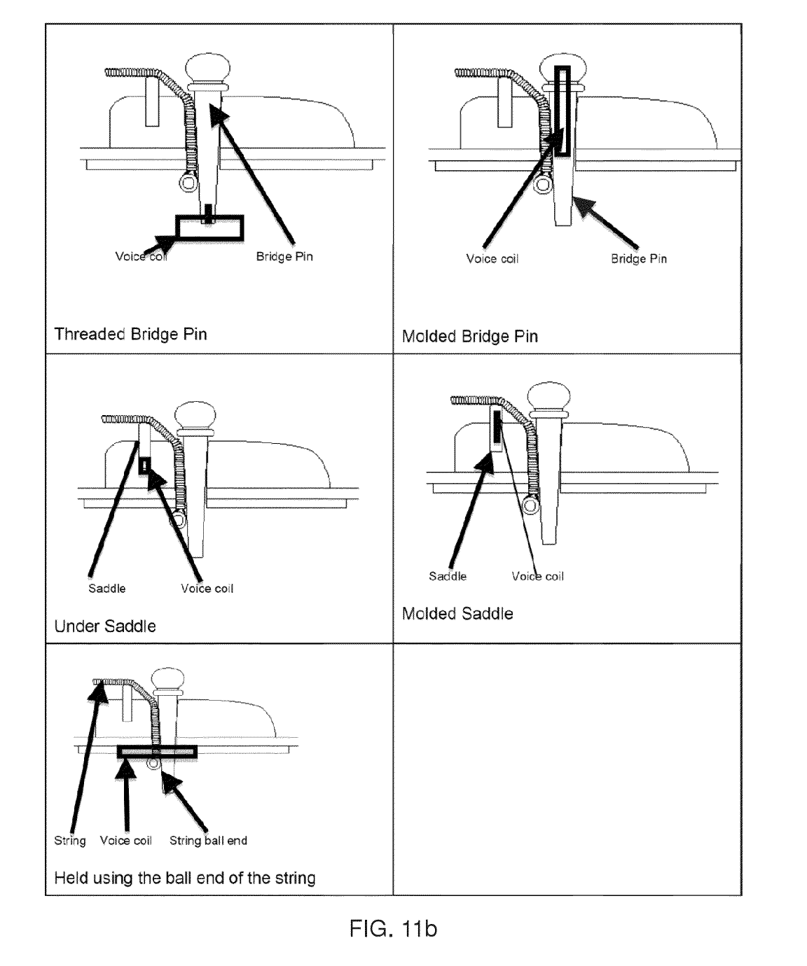

As shown in FIGS. 11a and 11b, aspects of the invention contemplate attaching some or all of the elements of the sub-system 105 to an instrument using suitable arrangement including, but not limited to: attaching the actuator device 125 to braces of a guitar using spring clamps; attaching the actuator device 125 under the saddle of a guitar using pressure of string tension to keep it in place; attaching the actuator device 125 inside the saddle, e.g., with the saddle molded around a voice coil or piezo of the actuator device 125; attaching the actuator device 125 inside a bridge pin, e.g., with one or more bridge pins molded around voice coil or piezo of the actuator device 125; attaching the actuator device 125 using a ball end of a string to hold the actuator device 125 in place at the inside of the guitar; attaching the actuator device 125 to a damped surface, e.g., with a voice coil or piezo of the actuator device 125 being clamped onto braces inside a guitar; attaching the actuator device 125 using a damped surface with voice a voice coil or piezo of the actuator device 125 using a threaded jack to pressure fit to sides; attaching the actuator device 125 using a spring loaded, scissor jack, threaded jack system using a back of a guitar to pressure fit a voice coil or piezo of the actuator device 125 to soundboard; and attaching the actuator device 125 using a threaded bridge pin that a voice coil or piezo of the actuator device 125 screws into. In FIGS. 11a and 11b, the “voice coil” may represent the secondary device 15 or actuator device 125 as described herein.

In this manner, implementations of the invention provide systems and methods of attaching one or more elements of sub-system 105 to an instrument. In one aspect, there is an attachment system comprising a system for attaching components of the device separately from each other to a musical instrument, e.g. some portions (for example, the communication device, processor device, energy source and capture device) are installed into sound hole of a guitar with clamping mechanisms, and other portions are mounted to the sound producing surfaces of the instrument. In another aspect, there is an attachment system comprising a system for attaching an actuator device 125 (e.g., voice coils or piezos) to a musical instrument that does not inhibit the ability to produce sound of the instrument without the device. In another aspect, there is an attachment system comprising a system for attaching an actuator device 125 (e.g., voice coils or piezos) to a musical instrument that optimizes the desired sound produced by the acoustic chamber when the actuator device is engaged.

Aspects of the invention also contemplate a method comprising: providing a system including the communication device, the capture device, the processor device, the actuator device, and the energy source; and providing instructions for how to install the system in a musical instrument. The system and instructions may be sold as a kit, e.g., separate from the instrument. The instructions may be printed and/or electronic, and may comprise at least one of text, audio, and video that explain how to install the system in a musical instrument, e.g., using one of the attachment methods shown in FIG. 11a or 11b.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A musical instrument, comprising:
a primary sound producing mechanism;
a primary sound producing surface, wherein movement of the primary sound producing mechanism by a user causes the primary sound producing surface to produce a sound;
a secondary device contacting the primary sound producing surface; and
a controller operatively connected to the secondary device and configured to cause the secondary device to vibrate the primary sound producing surface to produce a sound by the musical instrument.

2. The musical instrument of claim 1, wherein the musical instrument is a guitar, the primary sound producing mechanism is strings of the guitar, and the primary sound producing surface comprises the front surface or back surface of a body of the guitar.

3. The musical instrument of claim 2, wherein the secondary device is held in contact with the primary sound producing surface by a structural element connected to the guitar body.

4. The musical instrument of claim 2, wherein the secondary device receives a signal indicating a tone played by the strings and amplifies the tone by vibrating the primary sound producing surface.

5. The musical instrument of claim 4, wherein the signal is received from a pickup on the guitar or a computer device that is external to and separate from the guitar.

6. The musical instrument of claim 1, wherein the secondary device comprises a voice coil or at least one piezo element.

7. The musical instrument of claim 1, further comprising a power supply associated with the secondary device, and a contact-less recharging system for the power supply.

8. A system comprising the musical instrument of claim 1 and an external computer device, wherein the computer device comprises a processor, a memory, and programming stored in the memory and executed by the processor that causes the computer device to:
send a signal to the secondary device that causes the secondary device to produce a sound in the musical instrument by vibrating the primary sound producing surface.

9. The system of claim 8, wherein the computer device is separate from and external to musical instrument.

10. The system of claim 9, wherein the computer device comprises one of a laptop computer, tablet computer, desktop computer, and smart phone.

11. The system of claim 8, wherein the computer device sends the signal wirelessly to the secondary device.

12. The system of claim 8, wherein the signal is based on a predetermined sound comprising a note or chord associated with the musical instrument.

13. The system of claim 8, wherein the computer device receives an initial signal from the musical instrument, creates a processed signal by processing the initial signal, and sends the processed signal as the signal to the secondary device.

14. The system of claim 13, wherein the computer device is programmed to use voice control and/or accelerometer control to start/stop recording of the initial signal.

15. The system of claim 8, wherein the computer device receives an initial signal from another musical instrument different than the musical instrument, creates a processed signal by processing the initial signal, and sends the processed signal as the signal to the secondary device.

16. The system of claim 8, wherein the computer device receives an initial signal from a second computer device associated with another musical instrument different than the musical instrument, creates a processed signal by processing the initial signal, and sends the processed signal as the signal to the secondary device.

17. The system of claim 8, wherein the computer device causes the secondary device to produce an accompanying sound on the musical instrument while permitting a user to concurrently use the primary sound producing mechanism to produce an additional sound on the musical instrument.

18. A method that uses the musical instrument of claim 1, comprising using the secondary device to one of:
amplify a sound created by the primary sound producing mechanism; and
produce a sound in the musical instrument based on a signal received from a computer device that is external to and separate from the musical instrument.
